(19) United States
(12) Patent Application Publication
(10) Pub. No.: US 2004/0001749 A1
(43) Pub. Date: Jan. 1, 2004

(54) Trailer box

(76) Inventors: Peter Vanberlo, Simcoe (CA); Paul Phillips, Kenansville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/189,903

(22) Filed: Jul. 3, 2002

(30) Foreign Application Priority Data
Jun. 28, 2002 (CA) 2,390,050

(51) Int. Cl. B60P 1/00

(52) U.S. Cl. 414/528

(57) ABSTRACT

The invention provides a trailer box for receiving and discharging a load of freshly harvested tobacco leaves having an average minimum tobacco leaf dimension. The trailer box includes a frame carrying a deck having an upper surface. The trailer box also includes an endless conveyor adapted to travel over the upper surface on a rearward journey. The conveyor includes a conveying loop extending between axles mounted to the frame. The conveyor also includes support bars having upper support bar surfaces attached transversely to the conveying loop and spaced from each other a distance selected to be less than the average minimum tobacco leaf dimension to suspend the load. The conveying loop maintains a separation between the upper support bar surfaces and the upper surface of the deck during the rearward journey of the conveyor, selected to minimize friction between the suspended load and the upper surface of the deck.

### FIELD OF THE INVENTION

This invention relates to trailers and, more particularly, trailer boxes for receiving and discharging substantially whole freshly harvested tobacco leaves.

### BACKGROUND OF THE INVENTION

Tobacco leaves are usually harvested using tobacco harvesting machines, or combines. Typically, the freshly harvested tobacco leaves are transported in a container from the harvesting machine in the field to a transfer facility where the tobacco leaves are transferred to curing bins. The curing bins are subsequently placed in curing barns, where the tobacco leaves are bulk cured. A curing bin is disclosed in U.S. Pat. No. 4,520,579 (De Cloet et al.).

When the tobacco leaves are placed in the curing bin, the leaves should be open and flat. In particular the tobacco leaf surfaces should be generally parallel, and the leaves uniformly distributed in the curing bin. This permits effective bulk curing of the tobacco leaves. If the tobacco leaves are uniformly packed in the curing bin, then the heated and conditioned air which is forced between the leaves during bulk curing in the curing barn will flow uniformly through the curing bin. However, if the curing bin includes voids, the heated and conditioned air will tend to flow through the voids, with the result that some of the tobacco leaves will not be exposed to the heated and conditioned air to the extent necessary for proper curing.

Immediately after harvesting by a harvesting machine, the tobacco leaves typically are placed in a receptacle on the machine in a disordered and non-uniform mass. Also, leaves at the bottom of the receptacle on the harvesting machine tend to become compacted due to the weight of tobacco leaves pressing on the leaves at the bottom. In addition, depending on the moisture content of the leaves, the leaves may tend to agglomerate.

As noted above, it is desirable that the tobacco leaves are distributed substantially uniformly in the curing bin, with the tobacco leaves open and substantially parallel to each other. However, the result of mechanical harvesting is to provide a disordered and non-uniform mass of tobacco leaves in the receptacle at the harvesting machine, some of which may be compacted. The tobacco farmer therefore is confronted with the problem of how to achieve a substantially uniform distribution of leaves in the curing bin when the tobacco leaves are provided in the receptacle of the harvesting machine in a disordered and non-uniform mass.

Various methods are known which are intended to result in a uniform distribution of tobacco leaves in the curing bin. For example, in U.S. Pat. No. 6,321,758 B1 (Sturgill et al.), a tobacco transferring system is disclosed in which, after the tobacco leaves are transported in crates to a transfer facility, the tobacco leaves are subsequently dumped onto conveyors and spread out on the conveyors by various means. The conveyors ultimately move the tobacco leaves to a curing bin.

Another example is provided in U.S. Pat. No. 4,530,203 (De Cloet) which discloses a tobacco harvester discharge system for use in a harvesting machine intended to carry harvested tobacco leaves on air forced through a duct by a fan, in order to separate the tobacco leaves and distribute the tobacco leaves about a receptacle on the harvesting machine.

For various reasons, the known devices for transporting freshly harvested tobacco leaves prior to their deposit in curing bins are deficient. There is therefore a need for a trailer box for receiving and discharging substantially whole freshly harvested tobacco leaves.

### SUMMARY OF THE INVENTION

In a broad aspect of the present invention, there is provided a trailer box for receiving and discharging a load comprising a plurality of substantially whole freshly harvested tobacco leaves having an average minimum tobacco leaf dimension. The trailer box has a frame longitudinally extending between a front end and a rear end, and the frame carries a deck extending between the front end and the rear end. Also, the deck has an upper surface. The trailer box also includes an endless conveyor adapted to travel over the upper surface of the deck on a rearward journey and below the deck on a forward journey. In addition, the conveyor includes a conveying loop extending between a front axle and a rear axle mounted to the frame at the front and rear ends thereof. One of the axles is adapted to couple with a drive unit for activating the conveying loop to move in a loop about the axles. The conveyor also includes a number of support bars having upper support bar surfaces attached transversely to the conveying loop. The support bars are spaced from each other a first predetermined separation selected to be less than the average minimum tobacco leaf dimension to suspend the load. Also, the conveying loop maintains a second predetermined separation between the upper support bar surfaces and the upper surface of the deck during the rearward journey of the conveyor. The second predetermined separation is selected to minimize friction between the suspended load and the upper surface of the deck.

### BRIEF DESCRIPTION OF THE DRAWINGS

The invention will be better understood with reference to the drawings, in which:

FIG. 1 is an end view of a preferred embodiment of the trailer box receiving a load of substantially whole freshly harvested tobacco leaves unloaded from a receptacle on a tobacco harvesting machine into the trailer box;

FIG. 2 is a perspective view of the trailer box of FIG. 1, drawn at a larger scale, showing the trailer box discharging the load at a transfer facility;

FIG. 3 is a top view of the trailer box of FIG. 1, drawn at a smaller scale;

FIG. 4 is a partial section side view of the trailer box of FIG. 3;

FIG. 5 is a partial end view of the trailer box of FIG. 3 at an open back end of a body of the trailer box, with a drive unit shown in ghost outline, drawn at a larger scale;

FIG. 6 is a partial section side view of the trailer box of FIG. 3 showing an endless conveyor and a deck, drawn at a larger scale;

FIG. 7 is an isometric view of the trailer box of FIG. 3, drawn at a larger scale;

FIG. 8 is an isometric view of a portion of the trailer box of FIG. 7, showing a portion of the open back end of the body, drawn at a larger scale; and

FIG. 9 is an isometric view of the trailer box of FIG. 7, showing a front end wall of the body, drawn at a smaller scale.

### BRIEF DESCRIPTION OF THE PREFERRED EMBODIMENT(S)

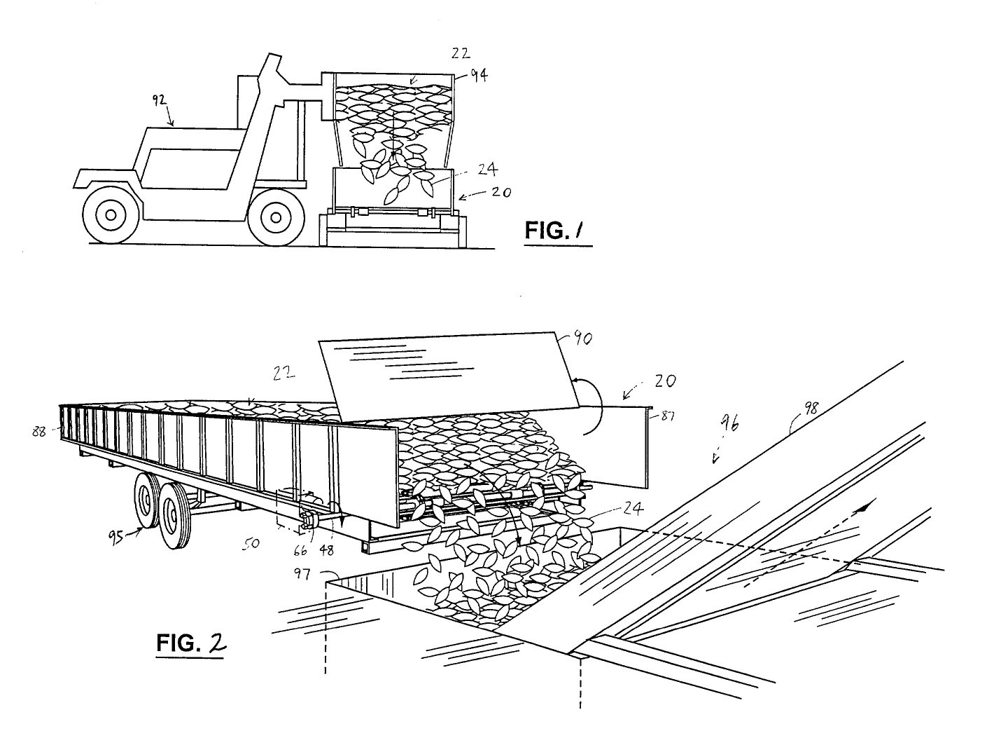

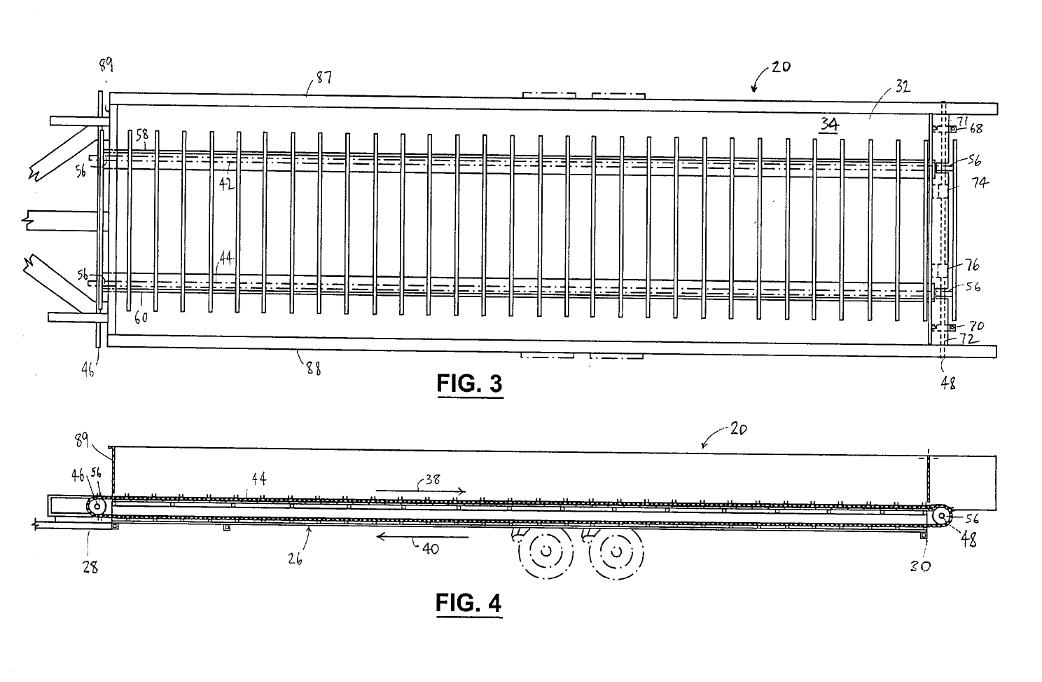

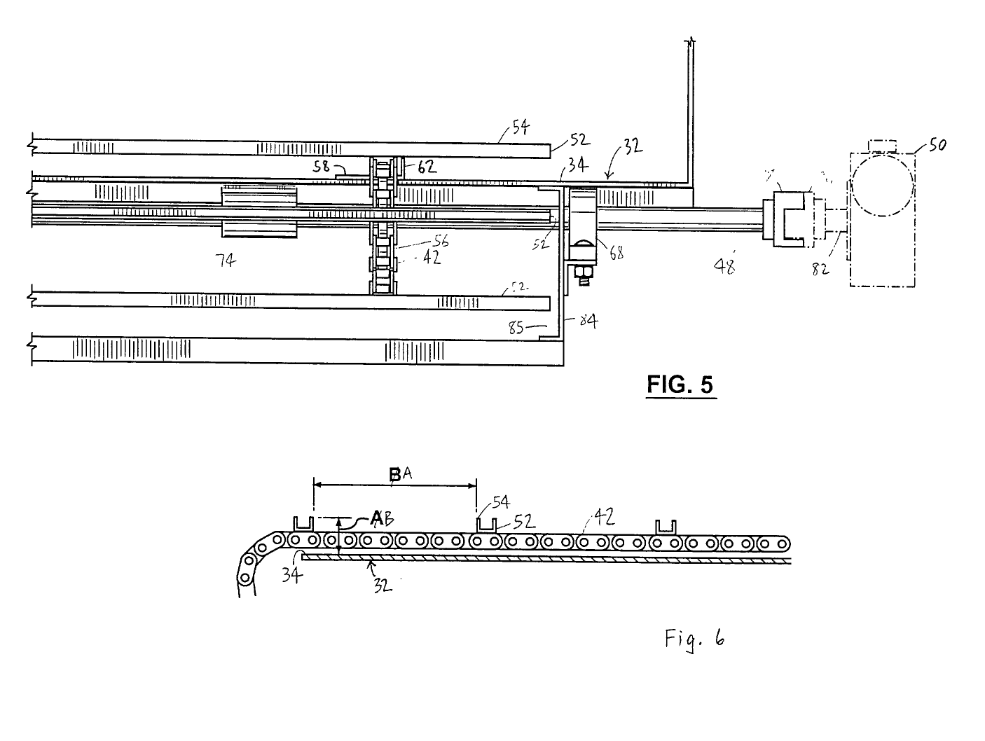

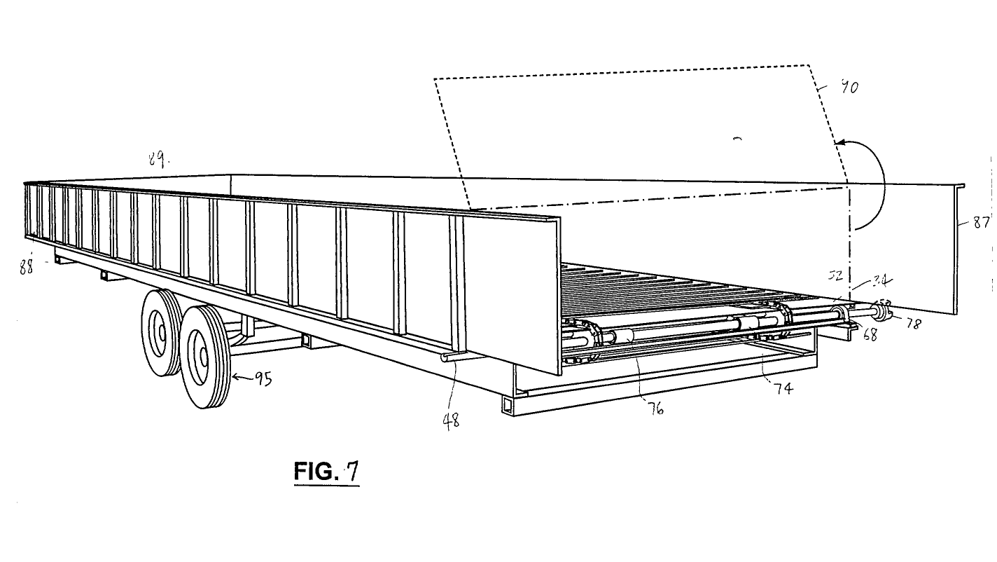

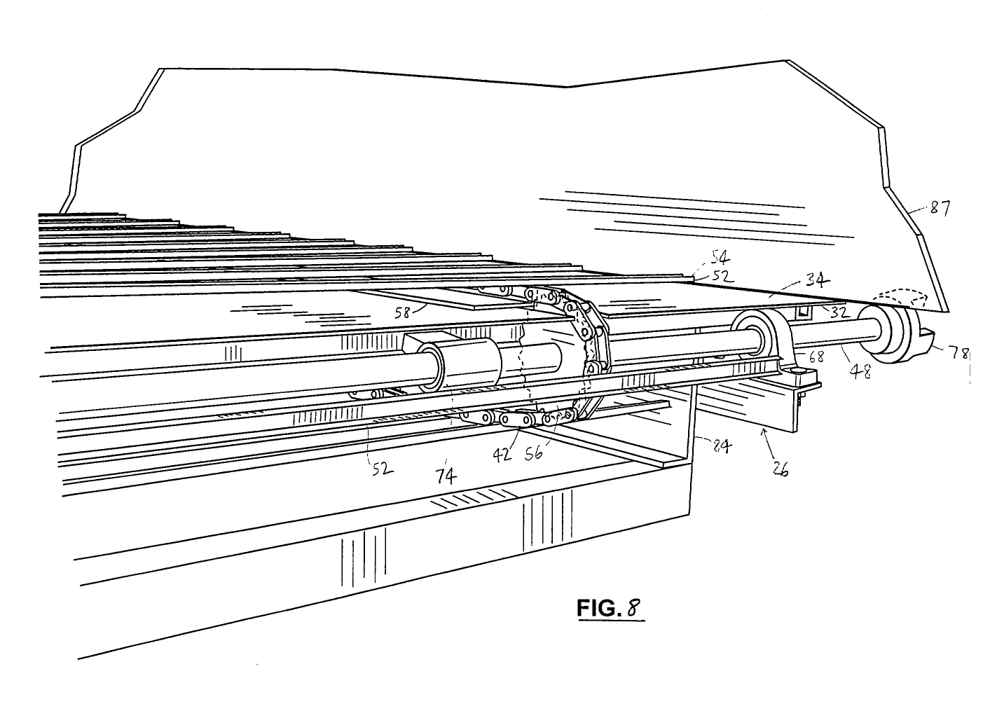

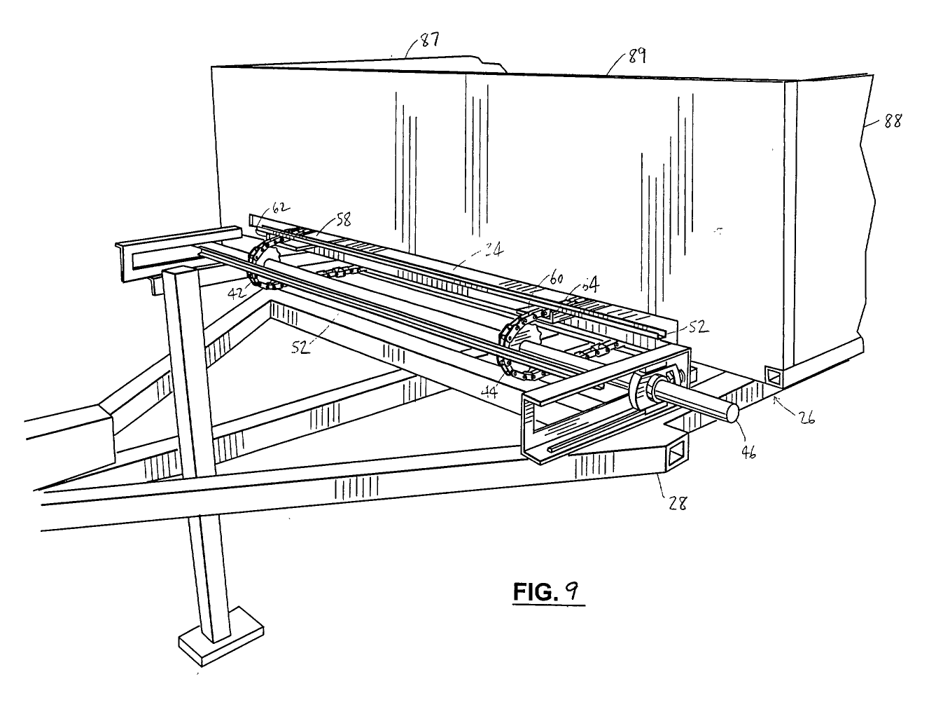

Reference is first made to FIGS. 1-6 to describe a preferred embodiment of a trailer box indicated generally by the numeral 20 in accordance with the invention. The trailer box 20 is for receiving and discharging a load 22 comprising a plurality of substantially whole freshly harvested tobacco leaves 24 having an average minimum tobacco leaf dimension (not shown), as can be seen in FIGS. 1 and 2. As shown in FIGS. 3 and 4, the trailer box 20 includes a frame 26 longitudinally extending between a front end 28 and a rear end 30. FIG. 4 shows that the frame 26 carries a deck 32 extending between the front end 28 and the rear end 30. As can be seen in FIGS. 5 and 6, the deck 32 has an upper surface 34, as will be described. The trailer box 20 also includes an endless conveyor 36 adapted to travel over the upper surface 34 of the deck 32 on a rearward journey, i.e., in the direction indicated by arrow 38 in FIG. 4, and below the deck 32 on a forward journey, as indicated in arrow 40 in FIG. 4. Although various arrangements can be used, in the preferred embodiment, the conveyor 36 includes two conveying loops 42, 44 extending between a front axle 46 and, a rear axle 48 mounted to the frame 26 at the front and the rear ends 28, 30 respectively. Preferably, one or both of the axles 46, 48 is adapted to couple with a drive unit 50, as will be described. The drive unit 50 is for activating the conveying loops 42, 44 each to move in a loop about the axles 46,48. as can be seen in FIG. 4. The conveyor 36 also includes a plurality of support bars 52 attached transversely to the conveying loops 42, 44, as shown in FIGS. 3 and 4. The support bars 52 have upper support bar surfaces 54, and the support bars 52 are spaced from each other a first predetermined separation A, shown in FIG. 6. The first predetermined separation A is selected to be less than the average minimum tobacco leaf dimension to suspend the load 22. In addition, the conveying loops 42, 44 maintain a second predetermined separation B, also shown in FIG. 6, between the upper support bar surfaces 54 and the upper surface 34 of the deck 32 during the rearward journey of the conveyor 36. The second predetermined separation B is selected to minimize friction between the suspended load 22 and the upper surface 34 of the deck 32.

Although the first predetermined separation A and the second predetermined separation B are shown in FIG. 6 in relation to the conveying loop 42, it will be understood that the positioning of the upper support bar surfaces 54 relative to each other and relative to the upper surface 34 of the deck 32 are the same for each of the conveying loops 42, 44.

Preferably, the axles 46, 48 include sprockets 56 mounted on the axles 46, 48. The conveying loops 42, 44 are preferably chain loops, as can be seen in FIGS. 4-6.

It is also preferred that the deck 32 additionally includes two chain guides 58, 60. As shown in FIG. 5, chain guide 58 forms a wall 62 which extends between the front end 28 and the rear end 30 for guiding the chain loop 42 during the rearward journey of the conveyor 36. It will be understood that chain guide 60 also forms a wall 64, also extending between the front end 28 and the rear end 30, for guiding the chain loop 44 during the rearward journey of the conveyor 36. Both chain guides 58, 60 can be seen in FIG. 9.

As can be seen in FIG. 5, it is preferred that the rear axle 48 functions as a drive shaft to which the drive unit 50 can be coupled by means of a coupling assembly 66. The drive shaft 48 is supported by bearings 68, 70 mounted to the frame 26 positioned proximate to opposite ends 71, 72 respectively of the drive shaft 48. The drive shaft 48 is also supported by bushings 74, 76, as shown in FIG. 3. The bushings 74, 76 are mounted to the frame 26 and support the drive shaft 48. Preferably, the bushings 74, 76 are, positioned between the bearings 68, 70. Preferably, the drive unit 50 is an electric motor, to obviate the consequences of using hydraulic or other fluids which could contaminate the load 22.

As is known in the art, the coupling assembly 66 comprises two coupling portions 78, 80 which cooperate with each other to couple an output shaft 82 of the drive unit 50 to the drive shaft 48.

Preferably, the frame 26 includes longitudinal members 84 extending between the front end 28, and the rear end 30. The longitudinal member 84 preferably defines a channel 85 for supporting the conveying loops 42, 44 on the forward journey under the deck 32.

The average tobacco leaf's minimum dimension is, typically, approximately ten inches. In view of this, it is preferred that the first predetermined separation A is approximately eight inches and the second predetermined separation B is approximately two inches.

It is also preferred that the trailer box 20 additionally includes a body 86 carried by the frame 26. The body 86 preferably has opposite side walls 87, 88 extending upwardly from the deck 32, and a front end wall 89 extending upwardly from the deck 32. The body 86 preferably also includes a tailgate 90 mounted between the side walls 87, 88 at an open back end 91 of the body 86. The tailgate 90 is movable between a closed position (as shown in FIGS. 3 and 4), in which the tailgate 90 closes the open back end 91 of the body 86, and an open position (as shown in FIG. 2) in which the back end 91 of the body 86 is substantially open.

Preferably, the support bars 52 are approximately seven and one-half feet long and the opposite side walls 87, 88 are positioned approximately eight feet apart. It is also preferred that the side walls 87, 88 extend approximately two feet upwardly from the deck 32 and the front end wall 89 extends approximately two feet upwardly from the deck 32. In the preferred embodiment, the deck 32 extends approximately thirty feet between the front end wall 89 and the back end 91.

In use, the load 22 comprises tobacco leaves 24 harvested by a harvesting machine 92 and placed in a receptacle 94. Typically, the tobacco leaves 24 are dumped from the receptacle 94 into the trailer box 20, as shown in FIG. 1. Often the receptacle 94 is approximately ten feet long. In the preferred embodiment, the deck 32 extends approximately thirty feet between the front end wall 89 and the back end 91. Accordingly, the trailer is filled with the load 22 after receiving three batches of tobacco leaves 24 from the receptacle 94, so that the load 22 is distributed along the deck 32. The dumping of the tobacco leaves 24 from the receptacle 94 into the trailer box 20 tends to separate and distribute the tobacco leaves 24,

Preferably, the trailer box 20 is relatively wide and long, serving to assist in the separation and distribution of the tobacco leaves 24 comprising the load 22. The trailer box 20 is preferably equipped with wheels 95 so that the trailer box 20 can be towed to a transfer facility 96 (shown in FIG. 2) by a self-propelled vehicle (not shown), such as a tractor. However, it is understood that the trailer box 20 could also be attached to and form part of a self-propelled vehicle (not shown). The transfer facility 96 can include a pit 97 with a transfer apparatus 98 disposed in the pit 97, as shown in FIG. 2. After the trailer box 20 is in position at the transfer facility 96, the tailgate 90 is moved to the open position, as can be seen in FIG. 2. Subsequently, the drive unit 50 is coupled to the drive shaft 48 by means of the coupling assembly 66. When the drive unit 50 is started, the drive unit 50 activates the conveying loops 42, 44, causing the conveyor to move rearward, and resulting in the load 22 being discharged at the transfer facility 96, as shown in FIG. 2. The pit 97 is configured so that, upon discharge, the load 22 drops a distance of approximately six feet from the trailer box 20 into the pit 97. The fall of the load 22 into the pit 97 tends to further separate and distribute the tobacco leaves 24.

Because the load 22 is suspended between the support bars 54 and the suspended load 22 is in minimal contact with the upper surface 34 of the deck 32, to minimize friction between the suspended load 22 and the upper surface 34, the load 22 can be discharged at the transfer facility 96 with a minimum of damage or bruising to the tobacco leaves 24.

It will be evident to those skilled in the art that the invention can take many forms, and that such forms are within the scope of the invention as claimed. For example, instead of chain loops being used as the conveying loops, other types Of loops can be employed. If other types of conveying loops were employed, such as conveying loops comprising nylon or similar suitable material, the conveying loops would engage with sheaves rather than sprockets. Other similar design choices may occur to those skilled in the art. Therefore, the spirit and scope of the appended claims should not be limited to the description of the preferred versions contained herein.

We claim

1. A trailer box for receiving and discharging a load comprising a plurality of substantially whole freshly harvested tobacco leaves having an average minimum tobacco leaf dimension, the trailer box having:
a frame longitudinally extending between a front end and a rear end;
the frame carrying a deck extending between the front end and the rear end, the dock having an upper surface;
an endless conveyor adapted to travel over the upper surface of the deck on a rearward journey and below the deck on a forward journey; and
the conveyor including at least one conveying loop extending between a front axle and a rear axle mounted to the frame at the front and rear ends thereof, at least one of said axles being adapted to couple with a drive unit for activating said at least one conveying loop to move in a loop about said axles and a plurality of support bars having upper support bar surfaces attached transversely to said at least one conveying loop and spaced from each other a first predetermined separation selected to be less than the average minimurn tobacco leaf dimension to suspend the load, said at least one conveying loop maintaining a second predetermined separation between the upper support bar surfaces and the upper surface of the deck during the rearward journey of the conveyor, the second predetermined separation being selected to minimize friction between the suspended load and the upper surface of the deck.

2. A trailer box according to claim 1 in which said axles include sprockets mounted thereon, and in which said at least one conveying loop comprises two chain loops for engagement with the sprockets.

3. A trailer box according to claim 2 in which the deck additionally includes two chain guides attached to the upper surface of the deck, each said chain guide forming a wall extending between the front end and the rear end for guiding said chain loops respectively during the rearward journey of said conveyor.

4. A trailer box according to claim 1 in which at least one of said axles is a drive shaft to which the drive unit can be coupled, the drive shaft being supported by bearings positioned proximate to opposite ends of the drive shaft and by at least one bushing positioned between said bearings for supporting the drive shaft.

5. A trailer box according to claim 1 in which the frame includes at least one channel positioned under the deck for supporting said at least one conveying loop on the forward journey under the deck.

6. A trailer according to claim 1 in which said first predetermined separation is approximately eight inches and said second predetermined separation is approximately two inches.

7. A trailer box according to claim 3 additionally including a body carried by the frame having opposite side walls extending upwardly from the deck, a front end wall extending upwardly from the deck, and a tailgate mounted between the side walls at an open back end of the body, the tailgate being movable between a closed position in which the tailgate closes the open back end of the body and an open position in which the back end of the body is substantially open.

8. A trailer according to claim 7 in which said support bars are approximately seven and one-half feet long and said opposite side walls are positioned approximately eight feet apart.

9. A trailer according to claim 7 in which the side walls extend approximately two feet upwardly from the deck.

10. A trailer according to claim 7 in which the front end wall extends approximately two feet upwardly from the deck.

11. A trailer according to claim 7 in which the deck extends approximately thirty feet between the front end wall to the back end.

12. A trailer box for receiving and discharging a load comprising a plurality of substantially whole freshly harvested tobacco leaves having an average minimum tobacco leaf dimension, the trailer box having:
a frame longitudinally extending between a front end and a rear end;
the frame carrying a deck extending between the front end and the rear end, the deck having an upper surface;
a body carried by the frame having opposite side walls extending upwardly from the deck, a front end wall extending upwardly from the deck and a tailgate mounted between the side walls at an open back end of the body, the tailgate being movable between a closed position in which the tailgate closes the open back end of the body and an open position in which the back end of the body is substantially open;
an endless conveyor adapted to travel over the upper surface of the deck on a rearward journey and below the deck on a forward journey, and
the conveyor including two conveying loops extending between a front axle and a rear axle mounted to the frame at the front and rear ends thereof, the conveying loops being positioned substantially parallel to each other, at least one of said axles being adapted to couple with a drive unit for activating said conveying loops to move in loops respectively about said axles and a plurality of support bars having upper support bar surfaces attached transversely to said conveying loops and spaced from each other a first predetermined separation selected to be less than the average minimum tobacco leaf dimension to suspend the load, each of said conveying loops maintaining a second predetermined separation between the upper support bar surfaces and the upper surface of the deck during the rearward journey of the conveyor, the second predetermined separation being selected to minimize friction between the suspended load and the upper surface of the deck.

13. A trailer box according to claim 12 in which said axles include sprockets mounted thereon, and in which said conveying loops comprise two chain loops for engagement with the sprockets.

14. A trailer box according to claim 23 in which the deck additionally includes two chain guides attached to the upper surface of the deck, each said chain guide forming a wall extending between the front end and the rear and for guiding said chain loops respectively during the rearward journey of said conveyor.

15. A trailer box according to claim 12 in which at least one of said axles is a drive shaft to which the drive unit can be coupled, the drive shaft being supported by bearings positioned proximate to opposite ends of the drive shaft and by at least one bushing positioned between said bearings for supporting the drive shaft.

16. A trailer box according to claim 12 in which the frame includes at least one channel positioned under the deck for supporting said at least one conveying loop on the forward journey under the deck.

17. A trailer box according to claim 12 in which said first predetermined separation is approximately eight inches and said second predetermined separation is approximately two inches.

18. A trailer box according to claim 12 in which said support bars are approximately seven and one-half feet long and said opposite side walls are positioned approximately eight feet apart.

19. A trailer box according to claim 12 in which the side walls extend approximately two feet upwardly from the deck.

20. A trailer box according to claim 12 in which the front end wall extends approximately two feet upwardly from the deck.

21. A trailer box according to claim 12 in which the deck extends approximately thirty feet from the front end wall to the back end.
